(19) United States
(12) Patent Application Publication
(10) Pub. No.: US 2026/0008404 A1
(43) Pub. Date: Jan. 8, 2026

(54) RIBBED FRICTION FIT ACCESSORY FOOT FOR CARGO BLOCKERS

(71) Applicant: Tmat Products, LLC, Wheatland, OK (US)

(72) Inventors: Nathan PARROW, Oklahoma City, OK (US); Kenneth AUSTIN, Mustang, OK (US)

(73) Assignee: Tmat Products, LLC, Wheatland, OK (US)

(21) Appl. No.: 19/092,019

(22) Filed: Mar. 27, 2025

Related U.S. Application Data
(60) Provisional application No. 63/667,560, filed on Jul. 3, 2024.
(60) Provisional application No. 63/738,938, filed on Dec. 26, 2024.

(51) Int. Cl. B60P 7/135

(52) U.S. Cl. CPC B60P 7/135

(57) ABSTRACT

A connector foot for attaching a cargo blocker to a storage mat includes a plurality of vertical walls and at least one protruding rib. The plurality of vertical walls include a first vertical side wall, a second vertical side wall, a first end wall, and a second end wall. The first vertical side wall having a first side wall first end point and a first side wall second end point. The second vertical side wall having a second side wall first end point and a second side wall second end point. The first end wall connecting the first side wall first end point to the second side wall second end point. The second end wall connecting the first side wall second end point to the second side wall second end point. The protruding rib extending from an outer surface of one of the first vertical side wall, the second vertical side wall, the first end wall, or the second end wall.

### CROSS REFERENCES AND PRIORITIES

This Application claims priority from U.S. Provisional Application No. 63/667,560 filed on 3 Jul. 2024 and U.S. Provisional Application No. 63/738,938 filed on 26 Dec. 2024, the teachings of each of which are incorporated by reference herein in their entirety.

### BACKGROUND

Friction-fit grid-based organization systems are widely used for securing cargo blockers, attachment points, and holders. Primarily used in truck beds, these systems include storage mats to which various cargo blockers or connectors can be attached, allowing for a customizable grid-like storage system for cargo of various shapes and sizes.

Existing connectors for such systems often lack features that facilitate alignment, retention, and adaptability to manufacturing tolerances. The need exists, therefore, for an improved connector for cargo blocks for grid-based organization systems which improves alignment and retention force.

### SUMMARY

Disclosed herein is a connector foot for attaching a cargo blocker to a storage mat. The connector foot includes a plurality of vertical walls and at least one protruding rib. The plurality of vertical walls includes at least a first vertical side wall, a second vertical side wall, a first end wall, and a second end wall. The first vertical side wall having a first side wall first end point and a first side wall second end point. The second vertical side wall having a second side wall first end point and a second side wall second end point. The first end wall connecting the first side wall first end point to the second side wall first end point. The second end wall connecting the first side wall second end point to the second side wall second end point. The at least one protruding rib extending from an outer surface of the first vertical side wall, the second vertical side wall, the first end wall, or the second end wall.

In some embodiments, the plurality of vertical side walls may further include a third vertical side wall, a fourth vertical side wall, and a third end wall. When present, the third vertical side wall may extend from a first side wall first intermediary position and may have a third side wall end point. Further, when present, the fourth vertical side wall may extend from a first side wall second intermediary position and may have a fourth side wall end point. The third end wall, when present, may connect the third side wall end point to the fourth side wall end point. In such embodiments, the plurality of vertical walls may be aligned in a “T” configuration. In such embodiments, the at least one protruding rib may extend from the outer surface of one of the first vertical side wall, the second vertical side wall, the third vertical side wall, the fourth vertical side wall, the first end wall, the second end wall, or the third end wall.

In certain embodiments having a third vertical side wall, a fourth vertical side wall, and a third end wall, the plurality of vertical side walls may further include a fifth vertical side wall, a sixth vertical side wall, and a fourth end wall. When present, the fifth vertical side wall may extend from a second side wall first intermediary position and may have a fifth side wall end point. Further, when present, the sixth vertical side wall may extend from a second side wall second intermediary position and may have a sixth side wall end point. The fourth end wall, when present, may connect the fifth side wall end point to the sixth side wall end point. In such embodiments, the plurality of vertical walls may be aligned in an “X” configuration. In such embodiments, the at least one protruding rib may extend from the outer surface of one of the first vertical side wall, the second vertical side wall, the third vertical side wall, the fourth vertical side wall, the fifth vertical side wall, the sixth vertical side wall, the first end wall, the second end wall, the third end wall, or the fourth end wall.

In some embodiments, the at least one protruding rib may be oriented vertically on the outer surface. In some such embodiments, the at least one protruding rib may not extend to a top of the vertical wall. In certain such embodiments, the at least one protruding rib may not extend to a bottom of the vertical wall.

In other embodiments, the at least one protruding rib may be oriented horizontally on the outer surface. In still other embodiments, the at least one protruding rib may be oriented diagonally on the outer surface.

In certain embodiments, the at least one protruding rib may comprise a plurality of protruding ribs. In some such embodiments, each protruding rib of the plurality of protruding ribs may extend from the outer surface of a different vertical wall of the plurality of vertical walls.

In some embodiments, the connector foot may also include a cargo block. When present, the cargo block may be attached to and extend upwardly from a connector foot top surface.

Also disclosed herein is an organization system kit. The organization system kit includes a plurality of connector feet and at least one storage mat. Each connector foot of the plurality of connector feet includes a plurality of vertical walls, at least one protruding rib, and a cargo block. The plurality of vertical walls includes at least a first vertical side wall, a second vertical side wall, a first end wall, and a second end wall. The first vertical side wall having a first side wall first end point and a first side wall second end point. The second vertical side wall having a second side wall first end point and a second side wall second end point. The first end wall connecting the first side wall first end point to the second side wall first end point. The second end wall connecting the first side wall second end point to the second side wall second end point. The at least one protruding rib extending from an outer surface of the first vertical side wall, the second vertical side wall, the first end wall, or the second end wall. The cargo block is attached to and extends upwardly from a connector foot top surface. The at least one storage mat includes a grid-like assortment of cutouts with each cut-out sized and shaped to accept a connector foot of the plurality of connector feet.

In some embodiments of the organization system kit, the at least one storage mat may include a plurality of storage mats. In some such embodiments, each storage mat of the plurality of storage mats may include a grid-like assortment of cutouts with each cut- out sized and shaped to accept a connector foot of the plurality of connector feet.

In some embodiments of the organization system kit, the plurality of vertical side walls may further include a third vertical side wall, a fourth vertical side wall, and a third end wall. When present, the third vertical side wall may extend from a first side wall first intermediary position and may have a third side wall end point. Further, when present, the fourth vertical side wall may extend from a first side wall second intermediary position and may have a fourth side wall end point. The third end wall, when present, may connect the third side wall end point to the fourth side wall end point. In such embodiments, the plurality of vertical walls may be aligned in a “T” configuration. In such embodiments, the at least one protruding rib may extend from the outer surface of one of the first vertical side wall, the second vertical side wall, the third vertical side wall, the fourth vertical side wall, the first end wall, the second end wall, or the third end wall.

In certain embodiments of the organization system kit having a third vertical side wall, a fourth vertical side wall, and a third end wall, the plurality of vertical side walls may further include a fifth vertical side wall, a sixth vertical side wall, and a fourth end wall. When present, the fifth vertical side wall may extend from a second side wall first intermediary position and may have a fifth side wall end point. Further, when present, the sixth vertical side wall may extend from a second side wall second intermediary position and may have a sixth side wall end point. The fourth end wall, when present, may connect the fifth side wall end point to the sixth side wall end point. In such embodiments, the plurality of vertical walls may be aligned in an “X” configuration. In such embodiments, the at least one protruding rib may extend from the outer surface of one of the first vertical side wall, the second vertical side wall, the third vertical side wall, the fourth vertical side wall, the fifth vertical side wall, the sixth vertical side wall, the first end wall, the second end wall, the third end wall, or the fourth end wall.

In some embodiments of the organization system kit, the at least one protruding rib may be oriented vertically on the outer surface. In some such embodiments, the at least one protruding rib may not extend to a top of the vertical wall. In certain such embodiments, the at least one protruding rib may not extend to a bottom of the vertical wall.

In other embodiments of the organization system kit, the at least one protruding rib may be oriented horizontally on the outer surface. In still other embodiments, the at least one protruding rib may be oriented diagonally on the outer surface.

In certain embodiments of the organization system kit, the at least one protruding rib may comprise a plurality of protruding ribs. In some such embodiments, each protruding rib of the plurality of protruding ribs may extend from the outer surface of a different vertical wall of the plurality of vertical walls.

### BRIEF DESCRIPTION OF FIGURES

FIG. 1 is an exemplary embodiment of a section of a storage mat utilizing a connector foot.

FIG. 2 is a bottom perspective view of an exemplary embodiment of a connector foot.

FIG. 3 is a bottom view of an exemplary embodiment of a connector foot.

FIG. 4 is a bottom perspective view of another exemplary embodiment of a connector foot.

FIG. 5 is a bottom perspective view of another exemplary embodiment of a connector foot.

FIG. 6 is a side view of an exemplary embodiment of a connector foot.

FIG. 7 is a perspective view of an exemplary embodiment of a cargo block with a connector foot.

FIG. 8 is an exemplary embodiment of a storage mat to which a connector foot may be connected.

FIG. 9 is an exemplary embodiment of a storage mat showing a possible arrangement of cargo blockers.

### DETAILED DESCRIPTION

Described herein is a connector foot for attaching a cargo blocker to a storage mat. Reference is made to the Figures in which, unless otherwise noted, like numbers refer to like structures. As described herein, the following numbers refer to the following structures as noted in the Figures.
5 refers to a storage mat.
7 refers to a cutout.
10 refers to a cargo blocker.
100 refers to a connector foot.
110 refers to a connector foot top surface.
200 refers to a vertical wall.
205 refers to an outer surface.
210 refers to a first vertical side wall.
211 refers to a first side wall first end point.
212 refers to a first side wall second end point.
213 refers to a first side wall first intermediary position.
214 refers to a first side wall second intermediary position.
220 refers to a second vertical side wall.
221 refers to a second side wall first end point.
222 refers to a second side wall second end point.
223 refers to a second side wall first intermediary position.
224 refers to a second side wall second intermediary position.
230 refers to a third vertical side wall.
231 refers to a third side wall end point.
240 refers to a fourth vertical side wall.
241 refers to a fourth side wall end point.
250 refers to a fifth vertical side wall.
251 refers to a fifth side wall end point.
260 refers to a sixth vertical side wall.
261 refers to a sixth side wall end point.
271 refers to a first end wall.
272 refers to a second end wall.
273 refers to a third end wall.
274 refers to a fourth end wall.
300 refers to a protruding rib.
400 refers to a cargo block.

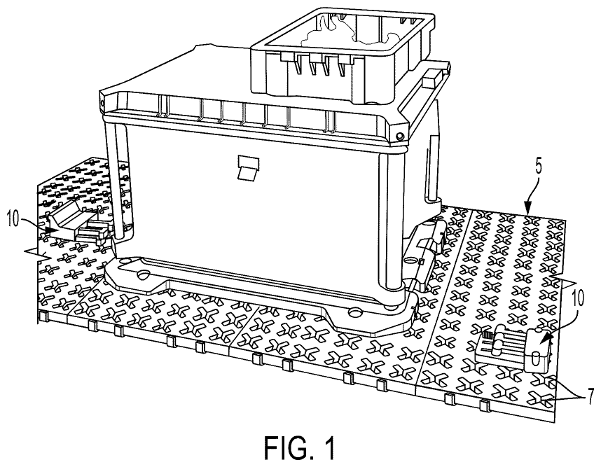

FIG. 1 illustrates a perspective view of an exemplary embodiment of a storage mat (5) with one or more cargo blockers (10). As shown in FIG. 1, the cargo blocker(s) are disposed and positioned within the storage mat. Each cargo blocker is disposed within a cutout (7) in the storage mat. The storage mat and associated cargo blockers assist in preventing movement of cargo disposed on top of the storage mat and are considered particularly useful when the cargo is being hauled to a different location—such as in the bed of a pickup truck. As the vehicle accelerates, decelerates, and turns, the cargo blockers—which may be disposed against a portion of at least three peripheral edges of the cargo—prevent the cargo from shifting with the forces caused by acceleration/deceleration/turning.

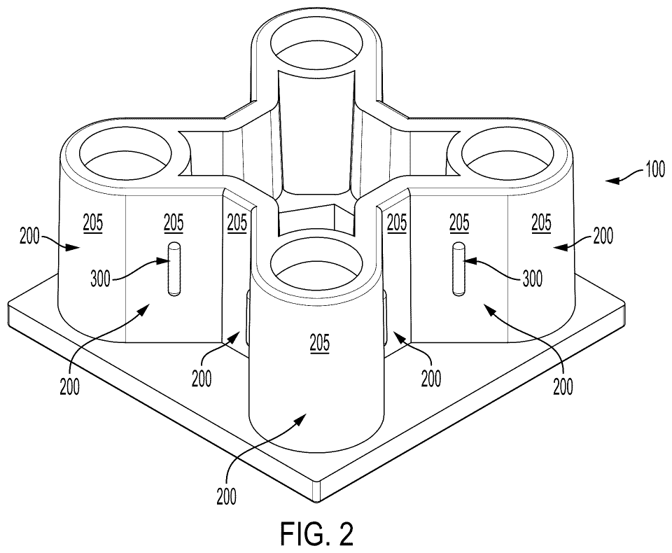

FIG. 2 illustrates a perspective view of an exemplary embodiment of a connector foot (100) for a cargo blocker ((10) as shown in FIG. 1). The connector foot being configured to dispose into the cutout(s) ((7) as shown in FIG. 1) in the storage mat ((5) as shown in FIG. 1) to locate the cargo blocker adjacent to the cargo. As shown in FIG. 2, the connector foot includes a plurality of vertical walls (200) with each vertical wall including an outer surface (205). Extending from the outer surface of at least one of the vertical walls is a protruding rib (300).

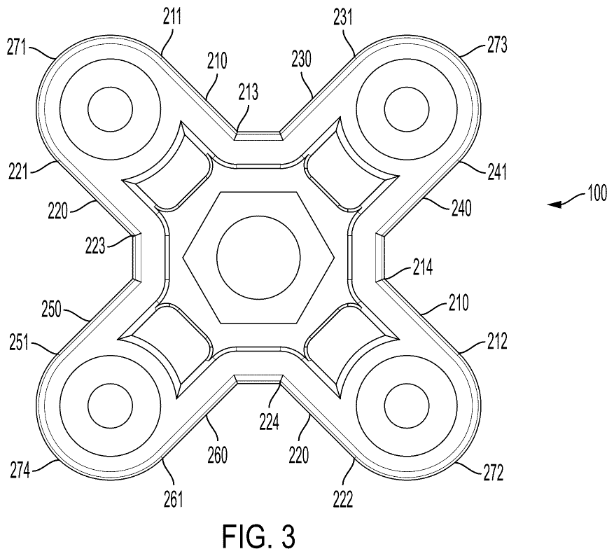

FIG. 3 illustrates a bottom view of an exemplary embodiment of a connector foot (100) for a cargo blocker ((10) as shown in FIG. 1) including additional details of the plurality of vertical walls ((200) as shown in FIG. 2). The plurality of vertical walls may take many forms. In general, the plurality of vertical walls will be sized and shaped to allow the connector foot to fit partially or fully within the cutout(s) ((7) as shown in FIG. 1) in the storage mat ((5) as shown in FIG. 1).

In some embodiments, the plurality of vertical walls (200) will include a first vertical side wall (210), a second vertical side wall (220), a first end wall (271), and a second end wall (272) forming an “I” shaped configuration. The first vertical side wall having a first side wall first end point (211) and a first side wall second end point (212) while the second vertical side wall has a second side wall first end point (221) and a second side wall second end point (222). Connected to and extending between the first side wall first end point and the second side wall first end point is the first end wall. In some embodiments, the first end wall may be curved as shown in the Figures while—in other embodiments—the first end wall may be planar. Connected to and extending between the first side wall second end point and the second side wall second end point is the second end wall. In some embodiments, the second end wall may be curved as shown in the Figures while—in other embodiments—the second end wall may be planar. In such embodiments, one or more of the protruding rib(s) ((300) as shown in FIG. 2) may extend from one or more of the first vertical side wall, the second vertical side wall, the first end wall, and/or the second end wall.

In certain embodiments, the plurality of vertical walls (200) may further include a third vertical side wall (230), a fourth vertical side wall (240), and a third end wall (273) forming a “T” shaped configuration. When present, the third vertical side wall will extend from a first side wall first intermediary position (213) and include a third side wall end point (231). Similarly, when present, the fourth vertical side wall will extend from a first side wall second intermediary position (214) and include a fourth side wall end point (241). Connected to and extending between the third side wall end point and the fourth side wall end point is the third end wall. In some embodiments, the third end wall may be curved as shown in the Figures while—in other embodiments—the third end wall may be planar. In such embodiments, one or more of the protruding rib(s) ((300) as shown in FIG. 2) may extend from one or more of the first vertical side wall, the second vertical side wall, the third vertical side wall, the fourth vertical side wall, the first end wall, the second end wall, and/or the third end wall.

In some embodiments, the plurality of vertical walls (200) may further include a fifth vertical side wall (250), a sixth vertical side wall (260), and a fourth end wall (274) forming an “X” shaped configuration as shown in FIG. 3. When present, the fifth vertical side wall will extend from a second side wall first intermediary position (223) and include a fifth side wall end point (251). Similarly, when present, the sixth vertical side wall will extend from a second side wall second intermediary position (224) and include a sixth side wall end point (261). Connected to and extending between the fifth side wall end point and the sixth side wall end point is the fourth end wall. In some embodiments, the fourth end wall may be curved as shown in the Figures while—in other embodiments—the fourth end wall may be planar. In such embodiments, one or more of the protruding rib(s) ((300) as shown in FIG. 2) may extend from one or more of the first vertical side wall, the second vertical side wall, the third vertical side wall, the fourth vertical side wall, the fifth vertical side wall, the sixth vertical side wall, the first end wall, the second end wall, the third end wall, and/or the fourth end wall.

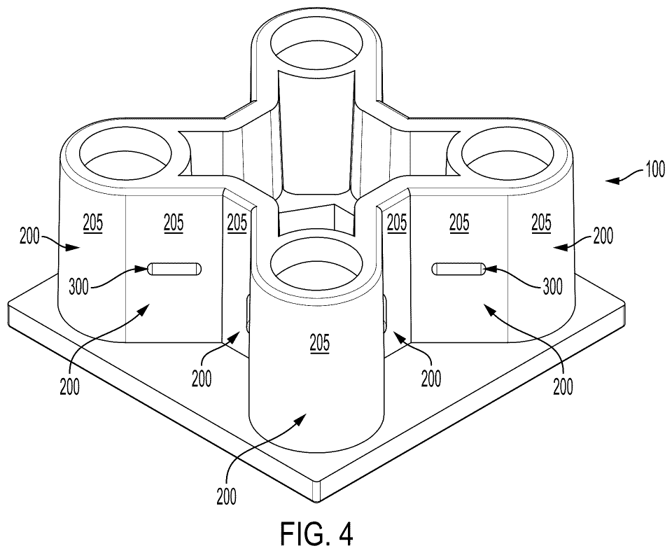

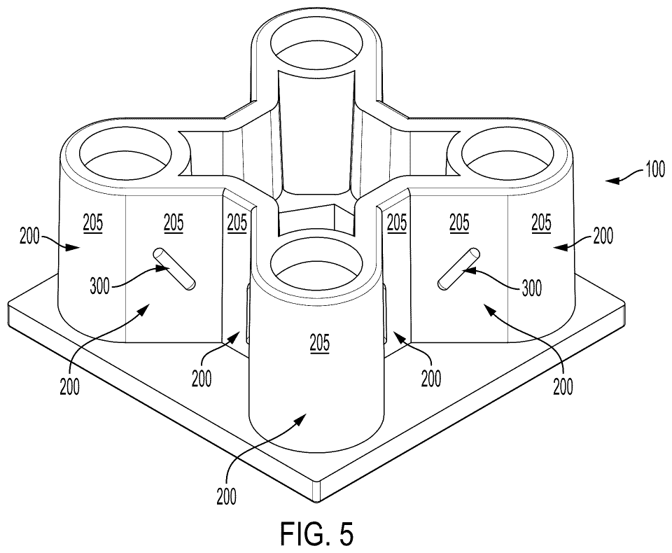

While FIG. 2 illustrates the protruding rib(s) (300) oriented vertically on the outer surface (205) of a vertical wall (200), other embodiments may exist. For example, in some embodiments, one or more of the protruding ribs may be oriented horizontally on the outer surface as shown in FIG. 4. In still other embodiments, one or more of the protruding ribs may be oriented diagonally on the outer surface as shown in FIG. 5.

In any embodiment, it is preferred that at least one—preferably all—of the protruding rib(s) (300) do not extend to a top of the vertical wall as shown in FIGS. 2, 4, and 5. It is also preferred that at least one—preferably all—of the protruding rib(s) do not extend to a bottom of the vertical wall as shown in FIGS. 2, 4, and 5.

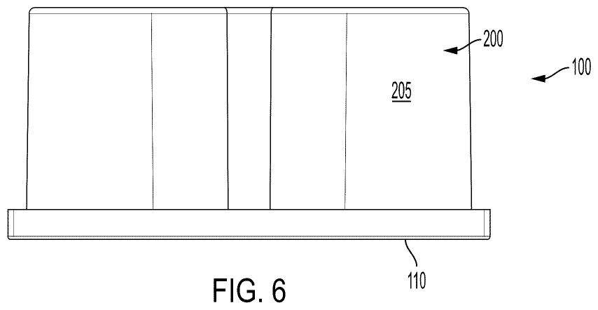

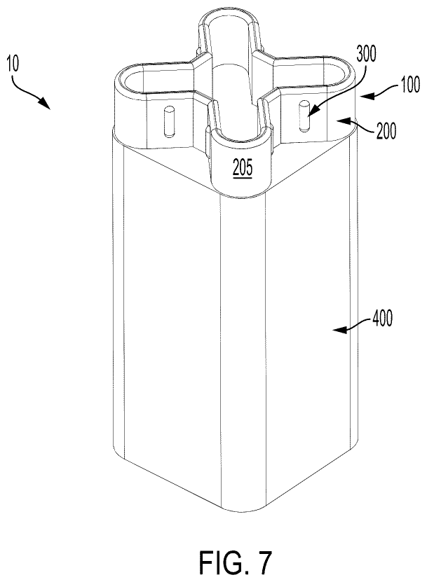

FIG. 6 illustrates a side view of an exemplary embodiment of a connector foot (100). As shown in FIG. 6, the connector foot includes a connector foot top surface (110). As illustrated in FIG. 7, a cargo block (400) is attached to and extends upwardly from the connector foot top surface. While FIG. 7 illustrates a simple embodiment of a cargo block having a substantially cuboid shape, many other embodiments may exist having complex geometries configured for specific types of cargo. As such, the cargo block may include one or more concave surfaces, one or move convex surfaces, one or more angled surfaces, one or more blind holes, one or more through holes, one or more slots, and combinations thereof.

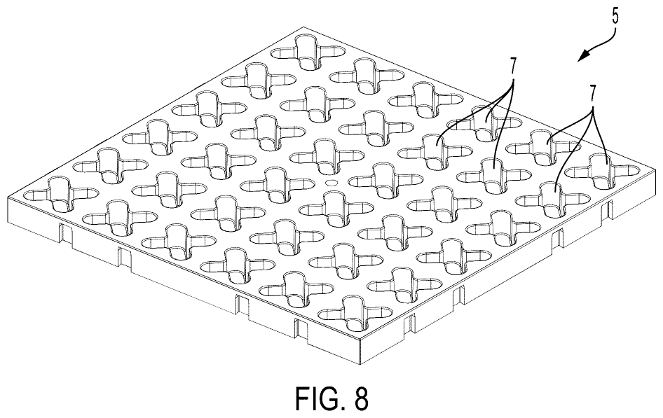

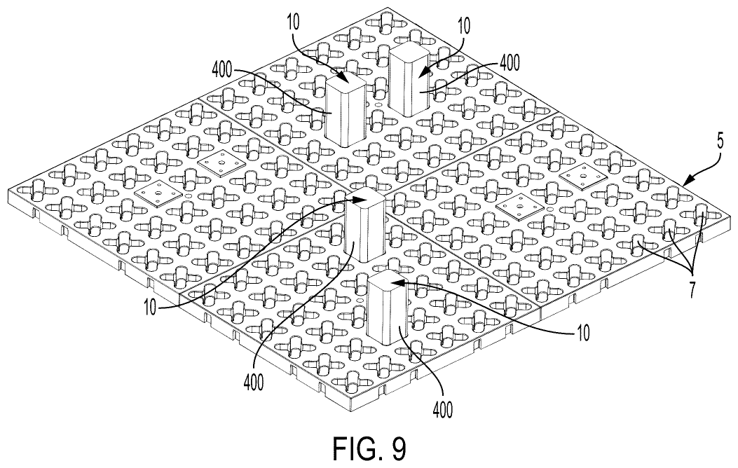

FIG. 8 illustrates an embodiment of a storage mat (5) with FIG. 9 showing a plurality of storage mats connected to one another with a plurality of cargo blockers (10) connected thereto. As shown in FIG. 9, when the connector foot ((100) as shown in FIG. 2) of the cargo blocker is disposed into the cutout (7), the cargo block (400) will extend upwardly from a top surface of the storage mat. Different combinations of cargo blocker(s) may be disposed into different cutouts in the storage mat to position the cargo blocker(s) to retain the specific piece of cargo disposed on top of the storage mat.

The connector foot (100) of any one individual cargo blocker (10) will be sized and shaped to fit within the cutout(s) (7) of the storage mat. That is to say that the external dimensions of the connector foot are preferably slightly less than the internal dimensions of the connector foot. The sole exception being the protruding rib(s) (300) which frictionally engage the internal wall(s) of the cutout(s) when the connector foot is inserted into the cutout

The connector feet (100) and storage mat (5) may be provided as an organization kit. The organization kit including a plurality of connector feet and at least one storage mat. Each connector foot of the plurality of connector feet may be provided in any form disclosed herein. The storage mat(s) in the kit will include a grid-like assortment of cutouts (7) with each cut-out sized and shaped to accept a connector foot of the plurality of connector feet.

The various components of the connector foot and the organization system kit may be fabricated of any number of materials utilizing any number of manufacturing techniques. Preferred materials include rigid plastics such as nylons, polyesters, and the like. However, other materials such as metals and woods may be utilized. Preferred manufacturing techniques—particularly when the components are fabricated of rigid plastics—include injection molding and additive manufacturing techniques (commonly referred to as 3D printing).

The connector foot described herein improves alignment and retention force when connecting a cargo block to a grid-based organization system. The protruding rib(s) serve as an alignment guide when inserting the connector foot into a cutout in the storage mat while also providing improved retention force when so installed. As the ribs—preferably—do not extend fully to the top or bottom of their respective vertical walls, the vertical area below the rib may assist as an alignment guide while the vertical area above the rib is thought to assist retention forces. As the connector foot is inserted, the rib causes the cut-out to flex outwardly. Once fully inserted, the flexible material of the adjacent storage mat is allowed to return to its original position. This then exerts a downward force on the top of the rib, increasing the resistance to removal. This ensures that the connector foot remains securely in place during use even when there is movement or vibration, such as when the system is used in the bed of a moving truck.

While the connector foot and the organization system kit have been described as having one or more exemplary designs, the present system may be further modified within the spirit and scope of this disclosure. This application is therefore intended to cover any variations, uses, or adaptations of the connector foot and the organization system kit using their general principles.

What is claimed is:

1. A connector foot (100) for attaching a cargo blocker (10) to a storage mat (5), said connector foot comprising:
a plurality of vertical walls (200) including at least:
a first vertical side wall (210) having a first side wall first end point (211) and a first side wall second end point (212);
a second vertical side wall (220) having a second side wall first end point (221) and a second side wall second end point (222);
a first end wall (271) connecting the first side wall first end point to the second side wall first end point; and
a second end wall (272) connecting the first side wall second end point to the second side wall second end point; and
at least one protruding rib (300) extending from an outer surface (205) of one of the first vertical side wall, the second vertical side wall, the first end wall, or the second end wall.

2. The connector foot of claim 1, wherein the plurality of vertical walls further includes:
a third vertical side wall (230) extending from a first side wall first intermediary position (213) and having a third side wall end point (231);
a fourth vertical side wall (240) extending from a first side wall second intermediary position (214) and having a fourth side wall end point (241); and
a third end wall (273) connecting the third side wall end point to the fourth side wall end point; and
wherein the plurality of vertical walls are aligned in a “T” configuration, and the at least one protruding rib extends from the outer surface of one of the first vertical side wall, the second vertical side wall, the third vertical side wall, the fourth vertical side wall, the first end wall, the second end wall, or the third end wall.

3. The connector foot of claim 2, wherein the plurality of vertical walls further includes:
a fifth vertical side wall (250) extending from a second side wall first intermediary position (223) and having a fifth side wall end point (251);
a sixth vertical side wall (260) extending from a second side wall second intermediary position (224) and having a sixth side wall end point (261); and
a fourth end wall (274) connecting the fifth side wall end point to the sixth side wall end point; and
wherein the plurality of vertical walls are aligned in an “X” configuration, and the at least one protruding rib extends from the outer surface of one of the first vertical side wall, the second vertical side wall, the third vertical side wall, the fourth vertical side wall, the fifth vertical side wall, the sixth vertical side wall, the first end wall, the second end wall, the third end wall, or the fourth end wall.

4. The connector foot of claim 1, wherein the at least one protruding rib is oriented vertically on the outer surface.

5. The connector foot of claim 4, wherein the at least one protruding rib does not extend to a top of the vertical wall.

6. The connector foot of claim 4, wherein the at least one protruding rib does not extend to a bottom of the vertical wall.

7. The connector foot of claim 1, wherein the at least one protruding rib is oriented horizontally on the outer surface.

8. The connector foot of claim 1, wherein the at least one protruding rib is oriented diagonally on the outer surface.

9. The connector foot of claim 1, wherein the at least one protruding rib comprises a plurality of protruding ribs with each protruding rib of the plurality of protruding ribs extending from the outer surface of a different vertical wall of the plurality of vertical walls.

10. The connector foot of claim 1, further comprising a cargo block (400) attached to and extending upwardly from a connector foot top surface (110).

11. An organization system kit comprising:
a plurality of connector feet, each connector foot (100) of the plurality of connector feet comprising:
a plurality of vertical walls (200) including at least:
a first vertical side wall (210) having a first side wall first end point (211) and a first side wall second end point (212);
a second vertical side wall (220) having a second side wall first end point (221) and a second side wall second end point (222);
a first end wall (271) connecting the first side wall first end point to the second side wall first end point;
a second end wall (272) connecting the first side wall second end point to the second side wall second end point; and
at least one protruding rib (300) extending from an outer surface (205) of one of the first vertical side wall, the second vertical side wall, the first end wall, or the second end wall; and
a cargo block (400) attached to and extending upwardly from a connector foot top surface (110); and
at least one storage mat (5) comprising a grid-like assortment of cutouts (7) with each cut-out sized and shaped to accept a connector foot of the plurality of connector feet.

12. The organization system kit of claim 11, wherein the at least one storage mat comprises a plurality of storage mats and each storage mat of the plurality of storage mats includes a grid-like assortment of cutouts with each cut-out sized and shaped to accept a connector foot of the plurality of connector feet.

13. The organization system kit of claim 11, wherein the plurality of vertical walls further includes:
a third vertical side wall (230) extending from a first side wall first intermediary position (213) and having a third side wall end point (231);
a fourth vertical side wall (240) extending from a first side wall second intermediary position (214) and having a fourth side wall end point (241); and
a third end wall (273) connecting the third side wall end point to the fourth side wall end point; and
wherein the plurality of vertical walls are aligned in a “T” configuration, and the at least one protruding rib extends from the outer surface of one of the first vertical side wall, the second vertical side wall, the third vertical side wall, the fourth vertical side wall, the first end wall, the second end wall, or the third end wall.

14. The organization system kit of claim 13, wherein the plurality of vertical walls further includes:
a fifth vertical side wall (250) extending from a second side wall first intermediary position (223) and having a fifth side wall end point (251);
a sixth vertical side wall (260) extending from a second side wall second intermediary position (224) and having a sixth side wall end point (261); and
a fourth end wall (274) connecting the fifth side wall end point to the sixth side wall end point; and
wherein the plurality of vertical walls are aligned in an “X” configuration, and the at least one protruding rib extends from the outer surface of one of the first vertical side wall, the second vertical side wall, the third vertical side wall, the fourth vertical side wall, the fifth vertical side wall, the sixth vertical side wall, the first end wall, the second end wall, the third end wall, or the fourth end wall.

15. The organization system kit of claim 11, wherein the at least one protruding rib is oriented vertically on the outer surface.

16. The organization system kit of claim 15, wherein the at least one protruding rib does not extend to a top of the vertical wall.

17. The organization system kit of claim 15, wherein the at least one protruding rib does not extend to a bottom of the vertical wall.

18. The organization system kit of claim 11, wherein the at least one protruding rib is oriented horizontally on the outer surface.

19. The organization system kit of claim 11, wherein the at least one protruding rib is oriented diagonally on the outer surface.

20. The organization system kit of claim 11, wherein the at least one protruding rib comprises a plurality of protruding ribs with each protruding rib of the plurality of protruding ribs extending from the outer surface of a different vertical wall of the plurality of vertical walls.
